(19) United States
(12) Patent Application Publication
(10) Pub. No.: US 2005/0064971 A1
(43) Pub. Date: Mar. 24, 2005

(54) Movable-body linear drive assembly

(76) Inventors: Naotaka Sasaki, Kiryu-shi (JP); Shunichi Kawamata, Kiryu-shi (JP); Kenji Sugaya, Kiryu-shi (JP); Yoshihisa Kagawa, Kiryu-shi (JP); Hideaki Ito, Kiryu-shi (JP)

Correspondence Address: BIRCH STEWART KOLASCH & BIRCH, PO BOX 747, FALLS CHURCH, VA, 22040-0747, US

(21) Appl. No.: 10/933,396

(22) Filed: Sep. 3, 2004

(30) Foreign Application Priority Data
Sep. 24, 2003 (JP) 2003-330807
Sep. 24, 2003 (JP) 2003-331179

(51) Int. Cl. F16H 59/00; F16H 61/00; F16H 63/00

(52) U.S. Cl. 474/148

(57) ABSTRACT

A movable-body linear drive assembly comprises: a drive source; a drive pulley connected to the drive source; an idler pulley which is disposed such that the idler pulley is spaced from the drive pulley by a distance; a belt which is wound around the drive pulley and the idler pulley, and which has a detection part; a movable body mounted on the belt; and at least one detector which detects the detection part of the belt.

### BACKGROUND OF THE INVENTION

1. Field of the Invention

The present invention relates to a movable-body linear drive assembly, which is used in a uniaxial actuator of production machinery, a recording apparatus or a medical device, for instance.

2. Description of Related Art

In a linear drive assembly including a rotary motor as a drive source to linearly move a movable body, it is typical to employ a stepping motor as the rotary motor, since employing a stepping motor is advantageous in many points, such as that it is enabled to position a movable body by an open-loop control, and to easily control the movable body by using a digital controller. On the other hand, the employing a stepping motor is disadvantage in a point that when the motor is operated in a fashion not suitable for the torque characteristic of the motor, synchronism with input signals is lost, making it impossible to precisely move to a desired position the movable body to which the drive force of the motor is transmitted.

Such a deviation of the position of the movable body from the desired or nominal position due to the loss of synchronism is a considerably serious problem, where the stepping motor is used in a uniaxial actuator of production machinery, recording apparatus or medical device. Therefore, it is required to monitor the status of the movement of the movable body, at any time, and to perform processing such as emergency stop or alarming, in the case of occurrence of an abnormality, i.e., the deviation of the actual movement of the movable body from the nominal movement.

Therefore, the conventional linear drive assembly is accompanied by means for generating a movement status monitor signal. Such monitor signal generating means monitors the movement status of the movable body including the current position and velocity of the movable body, and may be a reflection-type optical linear encoder or a linear potentiometer of resistance type, for instance.

However, the providing the monitor signal generating means separately from the linear drive assembly makes the structure of the assembly complex and pushes up the manufacturing cost also.

### SUMMARY OF THE INVENTION

Therefore, an object of the present invention is to provide an assembly for linearly driving a movable body, which is capable of monitoring the status of a movement of the movable body, simple in structure, and manufactured at a reduced cost.

To attain the above object, the invention provides a movable-body linear drive assembly comprising: a drive source; a drive pulley connected to the drive source; an idler pulley which is disposed such that the idler pulley is spaced from the drive pulley by a distance; a belt which is wound around the drive pulley and the idler pulley, and which has a detection part; a movable body mounted on the belt; and at least one detector which detects the detection part of the belt.

In the above movable-body linear drive assembly, a part of the means for generating a movement status monitor signal is integral with the means for transmitting the drive force of the drive source to the movable body. Thus, the assembly is simplified in structure, requires a reduced manufacturing cost, and is capable of monitoring the movement of the movable body.

### BRIEF DESCRIPTION OF THE DRAWINGS

FIG. 1 is a perspective view of a movable-body linear drive assembly according to a first embodiment of the present invention.

FIG. 2 is a perspective view of a drive pulley of the assembly of FIG. 1.

FIG. 3 shows an optical sensor of the assembly.

FIG. 4 is a block diagram of a controller used for controlling the assembly of FIGS. 1-3.

FIG. 5 shows a part of a movable-body linear drive assembly according to a second embodiment of the invention.

FIG. 6 shows a part of a movable-body linear drive assembly according to a third embodiment of the invention.

FIG. 7 shows a movable-body linear drive assembly according to a fourth embodiment of the invention.

FIG. 8 shows a drive pulley of the assembly of FIG. 7.

FIG. 9 shows a part of a movable-body linear drive assembly according to a fifth embodiment of the invention.

### DETAILED DESCRIPTION OF THE INVENTION

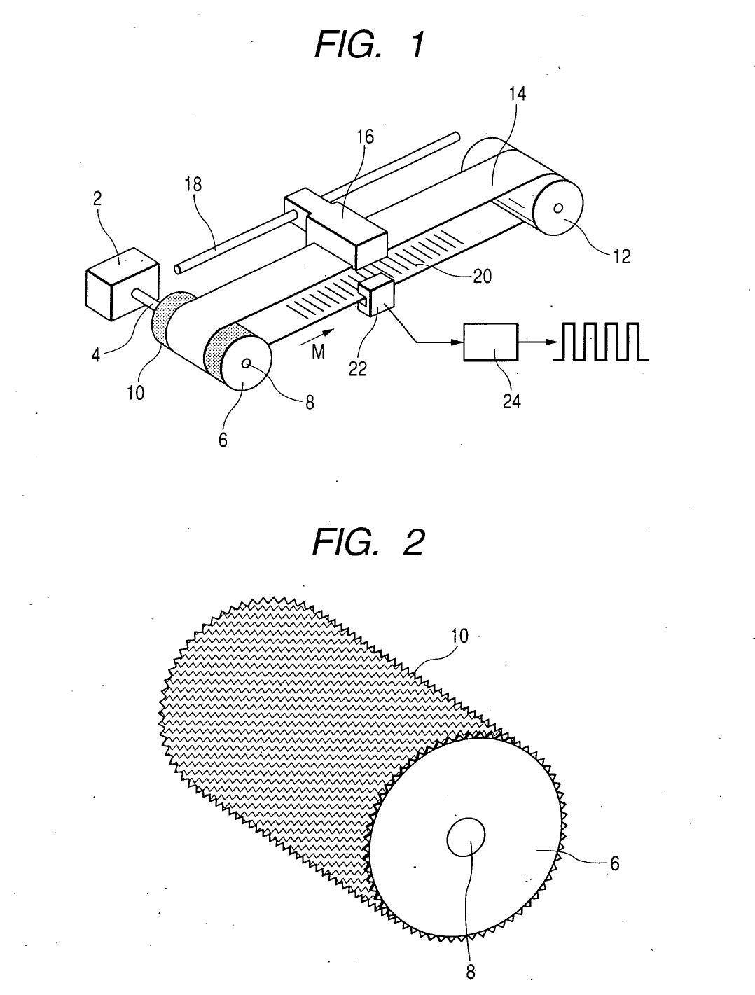

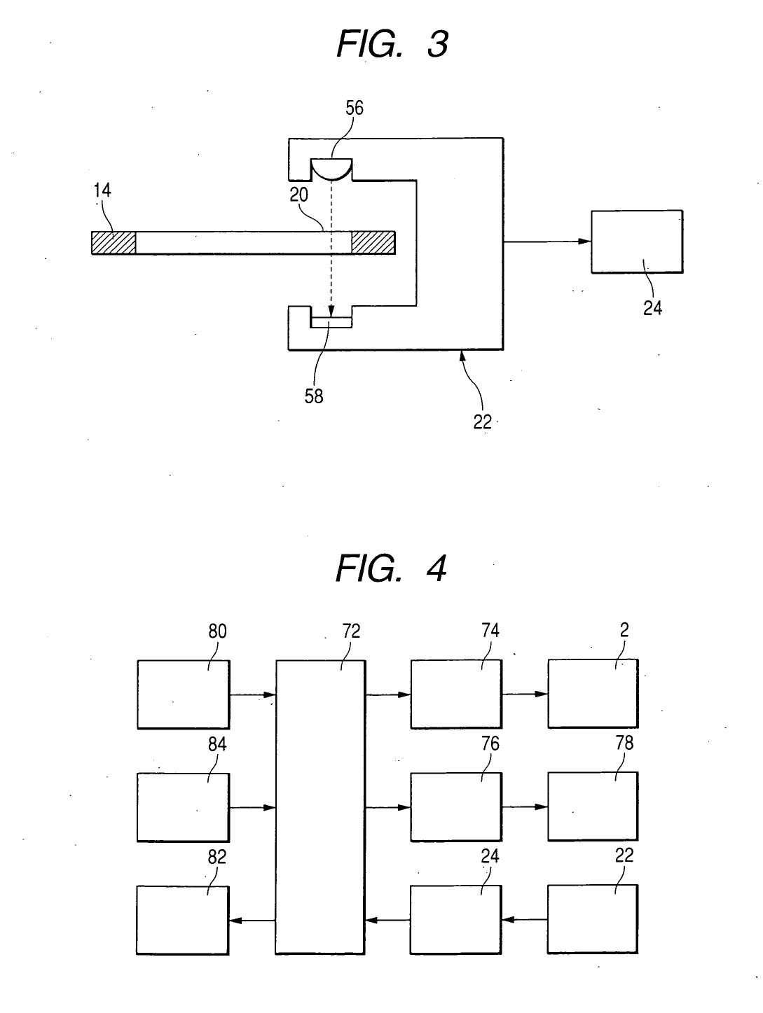

By reference to FIGS. 1-3, a movable-body linear drive assembly according to a first embodiment of the invention will be described. To an output shaft 4 of a stepping motor 2 as a drive source, there is connected a drive pulley 6 having an axis along which a hollow bore 8 is formed for mounting the output shaft 4 therein. An outer circumferential surface of the drive pulley 6 is roughened so as to increase the degree of frictional force generated between the surface and a sheet belt 14 which is wound around the drive pulley 6 and an idler pulley 12 which are spaced from each other by a distance. More specifically, multiple minute protrusions 10 are randomly formed on the outer circumferential surface of the drive pulley 6; the protrusions 10 are formed by, for instance, bonding fine alumina particles, or welding an artificial diamond powder, to the outer circumferential surface. A movable body 16 is mounted on the belt 14, and linear movement of the movable body 16 is guided by a guide 18. Multiple slits 20, each having a predetermined width, are formed through the belt 14, in a row with a constant pitch. The slits 20 serve as a detection part of the belt 14 to be detected by a detector, and need not be formed over an entire length of the belt 14, but it suffices that the slits 20 are formed at respective positions over a range which corresponds to a distance or range of movement of the movable body 16 to be monitored. Further, a transmission-type optical sensor 22 as the detector is disposed such that two arms of the sensor 22 are located on the upper and lower sides of the belt 14, respectively; more specifically, an upper one of the arms of the sensor has a light emitting element 56 while the other or lower arm has a light receiving element 58, so as to detect whether a slit 20 is present between the elements 56, 58. The assembly further comprises a signal processing circuit 24 which receives an output signal from the optical sensor 22 and outputs an encoder signal A of single phase, as a movement status monitor signal. The slits 20, optical sensor 22 and signal processing circuit 24 constitute a means for generating a movement status monitor signal.

In the movable-body linear drive assembly, when the stepping motor 2 rotates the drive pulley 6, the belt 14 is entrained about the pulleys 6, 12 to circulate in a first direction indicated by arrow M in FIG. 1, and the movable body 16 linearly moves in a second direction opposite to the first direction. While any of the slits 20 is present above the light receiving element 58, a light radiated from the light emitting element 56 passes through the slit 20, without being blocked by the belt 14, and reaches the light receiving element 58 which is thus activated. Then, the belt 14 is moved to establish a state where any of the slits 20 is not present above the light receiving element 58. In this state, the light radiated from the light emitting element 56 is blocked by the belt 14, deactivating the light receiving element 58. The optical sensor 22 thus detects whether any of the slits 20 is present above the light receiving element 58, and outputs a signal as a result of the detection, depending upon the movement of the belt 14, to the signal processing circuit 24, which in turn outputs the encoder signal A of single phase corresponding to the signal outputted from the optical sensor 22.

The movable-body linear drive assembly having the means for generating the movement status monitor signal can monitor the movement status of the movable body 16. Further, since the means itself for transmitting the drive force of the stepping motor 2 to the movable body 16 has the slits 20 as a part of the means for generating the movement status monitor signal, the assembly is simplified in structure while resolving the problem of the complex assembling and adjusting processes which has been conventionally encountered, and reducing the manufacturing cost as well. Still further, the providing the minute protrusions 10 on the outer circumferential surface of the drive pulley 6 prevents occurrence of a slip between the drive pulley 6 and the belt 14, enables a transmission of the drive force of the stepping motor 2 to the movable body 16 with reliability.

Referring now to FIG. 4 which is a block diagram of a controller used for controlling the movable-body linear drive assembly shown in FIGS. 1-3, upon receiving a signal inputted by an operator through an operating key or keys 80, a microprocessor 72 sends a predetermined drive command to a motor driver 74 to drive the stepping motor 2, and monitors, at any time, the encoder signal A outputted from the signal processing circuit 24 so as to determine whether the belt 14, and accordingly the movable body 16, is moving in accordance with this drive command. In a case where a pulse waveform of the encoder signal A is desirable or nominal, meaning that the movable body 16 is moving as desired, the microprocessor 72 controls a driver 76 of a hand mechanism 78 of the movable body 16 according to a predetermined control sequence, to continue the operation of moving the movable body 16. On the other hand, in a case where the pulse waveform of the encoder signal A is not nominal, the microprocessor 72 immediately operates to stop driving the stepping motor 2 and provide an abnormality alarm by turning on an indicator lamp 82. Such processing in response to the movement abnormality is performed also when the operator sees the abnormality in the operation of the assembly and manipulates an emergency stop button 84.

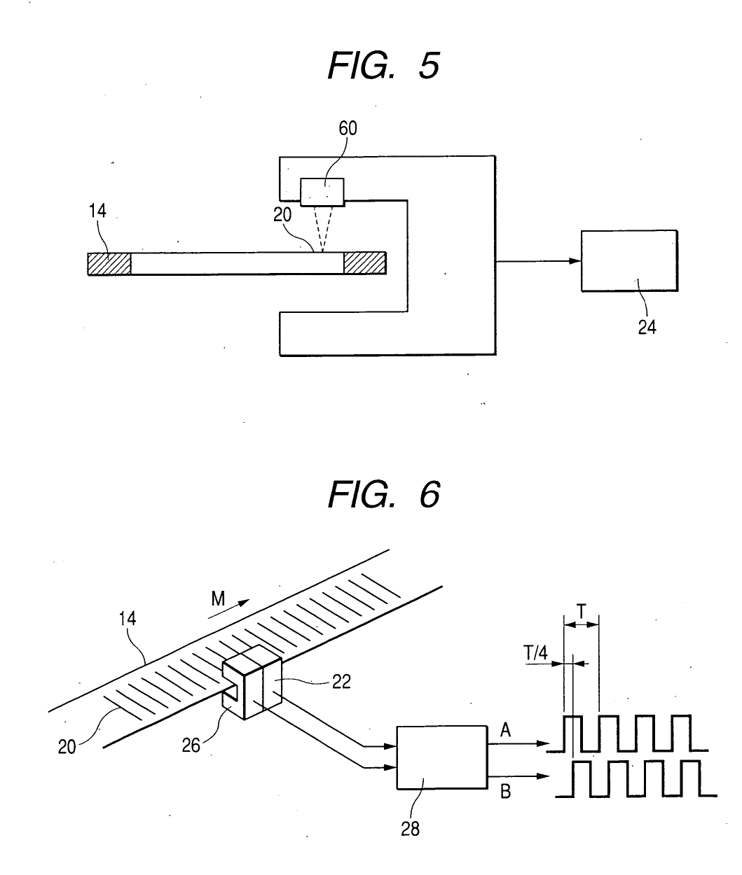

FIG. 5 shows a part of a movable-body linear drive assembly according to a second embodiment of the invention. In the present assembly, a light emitting element and a light receiving element of an optical sensor are provided by a single element, namely, a light emitting and receiving element 60. In addition, a light reflecting material is employed as a material of the belt 14, that is, the belt 14 has a surface which reflects light, and the light emitting and receiving element 60 is positioned such that an optical axis of the element 60 is properly turned at the light reflecting surface of the belt 14. Consequently, while any of the slits 20 is present on the optical axis of the element 60, a light emitted from the element 60 is not reflected by the belt 14, deactivating the element 60. Then, the belt 14 is moved to establish a state where any of the slits 20 is not on the optical axis of the element 60, in which state the light from the element 60 is reflected by the surface of the belt 14, activating the element 60. The signal processing circuit 24 accordingly outputs an encoder signal A represented by a pulse waveform as shown in FIG. 1.

Since the movable-body linear drive assembly shown in FIG. 1 is designed to obtain the encoder signal A of single phase as the movement status monitor signal, the movement of the belt 14, or of the movable body 16, is detected with no concern for the direction of the movement. However, in some applications, the movable-body linear drive assembly need be capable of monitoring the movement status of the movable body 16 including the direction of the movement. FIG. 6 shows a movable-body linear drive assembly according to a third embodiment of the invention, which is made for meeting such a demand. In the assembly of the third embodiment, a second optical sensor 26 is provided so that an encoder signal of two phases A, B can be obtained from a signal processing circuit 28. The optical sensor 22 and an optical sensor 26 are spaced from each other by a distance such that the phases A, B of the encoder signal respectively corresponding to these sensors 22, 26 are differentiated by ¼ of one cycle T. Instead of the second optical sensor 26, an index plate (not shown) may be provided to generate the encoder signal of two phases A, B.

In a case where a reflection-type optical sensor is employed as the detector, a second reflection-type optical sensor is further provided, to obtain an encoder signal of two phases A, B as shown in FIG. 6.

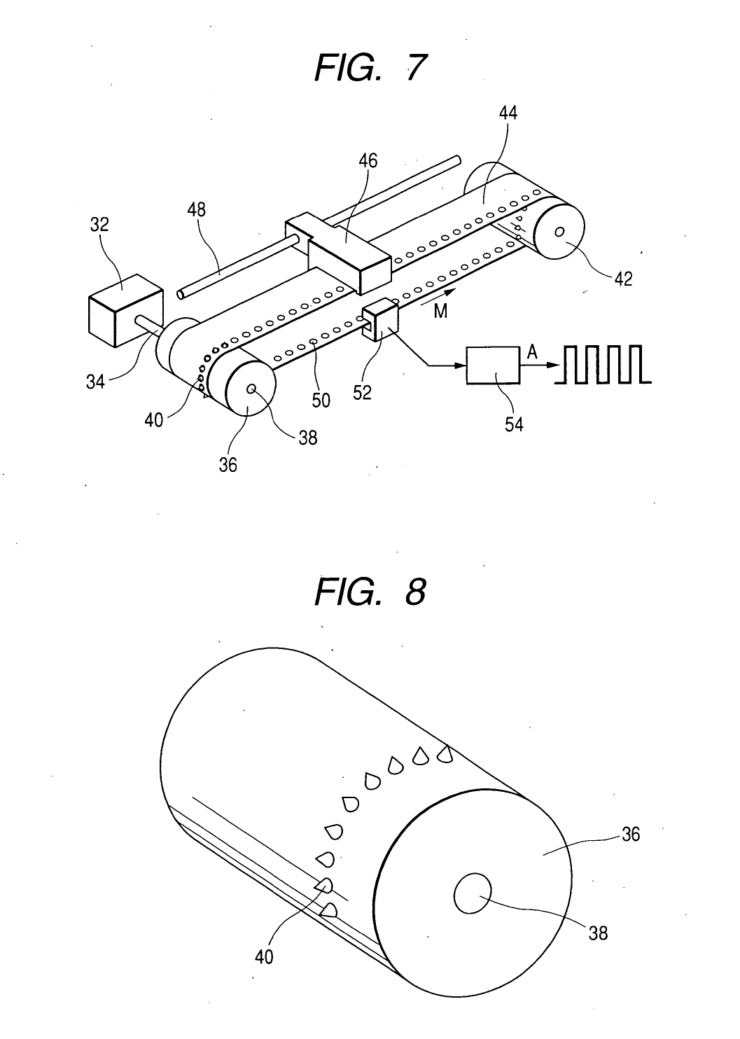

There will be described a movable-body linear drive assembly according to a fourth embodiment of the invention, by reference to FIGS. 7 and 8. To an output shaft 34 of a stepping motor 32 is connected a drive pulley 36 having an axis along which a hollow bore 38 is formed for mounting the output shaft 34 therein. There are provided a plurality of sprocket pins 40 on an outer circumferential surface of the drive pulley 36. The sprocket pins 40 are embedded in the outer circumferential surface of the drive pulley 36, or formed integrally with the drive pulley 36 by cutting or molding. An idler pulley 42 is disposed such that the idler pulley 42 is spaced from the drive pulley 36 by a distance, and a sheet belt 44 is wound around these pulleys 36, 42 to be circulated by the pulleys 36, 42. A movable body 46 is mounted on the belt 44, whose linear movement is guided by a guide 48. A plurality of sprocket holes 50 are formed through the belt 44 in a row with a constant pitch, so that the sprocket pins 40 engage with the sprocket holes 50. The sprocket holes 50 also serve as a detection part of the belt 44 to be detected by a detector, and need not be formed over an entire length of the belt 44, but it suffices that the sprocket holes 50 are formed at respective positions over a range which corresponds to a distance or range over which the engagement of the sprocket pins 40 with the sprocket holes 50 is required, depending upon the distance or range of the movement of the movable body 46. Further, a transmission-type optical sensor 52 as the detector is disposed such that two arms of the sensor 52 are located on the upper and lower sides of the belt 44, respectively. The optical sensor 52 is constructed similarly to the optical sensor 22 according to the first embodiment as shown in FIG. 1. The assembly further comprises a signal processing circuit 54 which receives an output signal from the optical sensor 52 and outputs an encoder signal A of single phase, as a movement status monitor signal.

In the movable-body linear drive assembly, when the stepping motor 32 rotates the drive pulley 36, the belt 44 is entrained about the pulleys 36, 42 to circulate in a first direction indicated by arrow M in FIG. 7, and the movable body 46 linearly moves in a second direction opposite to the first direction. The optical sensor 52 detects whether any one of the sprocket holes 50 is present between two arms of the sensor 52, and outputs a signal depending upon the movement of the belt 44, to the signal processing circuit 54 which in turn outputs the encoder signal A of single phase corresponding to the signal outputted from the optical sensor 52.

The movable-body linear drive assembly having a means for generating the movement status monitor signal, can monitor the movement status of the movable body 46. Further, since the means itself for transmitting the drive force of the stepping motor 32 to the movable body 46 has the sprocket holes 50 as a part of the means for generating the movement status monitor signal, the assembly is simplified in structure while resolving the problem of the complex assembling and adjusting processes which has been conventionally encountered, and reducing the manufacturing cost as well. Still further, the configuration where the sprocket pins 40 of the driver pulley 36 are engaged with the sprocket holes 50 of the belt 44 prevents occurrence of a slip between the drive pulley 36 and the belt 44, enables a transmission of the drive force of the stepping motor 32 to the movable body 46 with reliability.

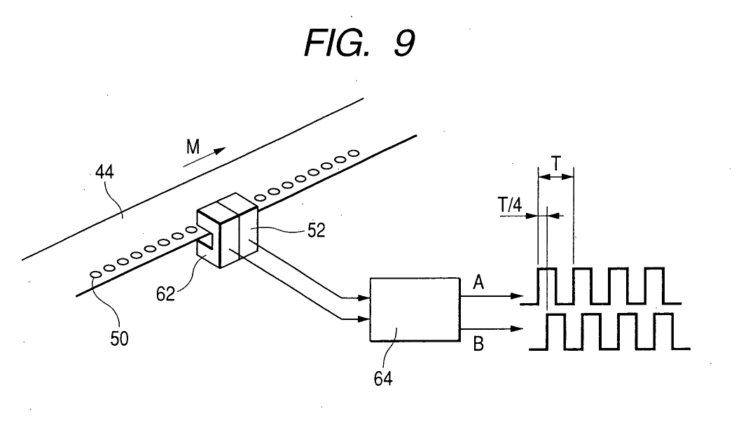

FIG. 9 shows a part of a movable-body linear drive assembly according to a fifth embodiment of the invention. In the present assembly, an optical sensor 62 is further provided so that a signal processing circuit 64 outputs an encoder signal of two phases A, B. The optical sensors 52, 62 are spaced from each other by a distance such that the phases A, B of the encoder signal respectively corresponding to these sensors 52, 62 are differentiated by ¼ of one cycle T.

In a case where a reflection-type optical sensor is employed, a second reflection-type optical sensor is further provided, to obtain an encoder signal of two phases A, B as shown in FIG. 9.

In each of the above embodiments, the belt 14, 44 has the slits 20 or sprocket holes 50 as the detection part by detecting which the detector or sensors 22, 26, 52, 60, 62 obtains an optical signal. However, the detection part may be otherwise provided. There will be described three other modes of the detection part. A first mode is as follows. The belt is made of a material which reflects light, and a plurality of optically absorptive black marks each in a band-like shape having a predetermined width are printed in a row with a constant pitch, on a surface of the belt by which a light is reflected. A reflection-type optical sensor is employed as the detector to detect whether any of the optically absorptive marks is present between two arms of the sensor. As the belt moves, the light emitted from the reflection-type optical sensor is alternately absorbed and reflected by the belt in accordance with the alternate presence and absence of the optically absorptive marks as the detection part. Consequently, the encoder signal identical with that of any of the above-described embodiments can be obtained. The optically absorptive marks are preferably provided on the outer surface of the belt, that is, the surface which is opposite to the surface brought into contact with the outer circumferential surface of the drive pulley where minute protrusions are provided.

A second mode is as follows. The belt is made of a magnetic material and has a magnetic characteristic. As the detection part, a plurality of magnetic marks, each having a predetermined width, are provided in a row with a constant pitch, on a surface of the belt. On the other hand, a magnetic sensor is employed as the detector to detect whether any of the magnetic marks is present at a position sensed by the sensor, by observing the change in the polarity in accordance with the alternate presence and absence of the marks. Further, the configuration of the signal processing circuit is appropriately modified. According to this second mode, as the movable body moves, the belt moves correspondingly and an according pulse signal can be obtained. Thus, a movement status monitor signal similar to that in any of the embodiments described above can be obtained.

A third mode is as follows. The belt is made of a magnetic material and has a magnetic characteristic. As the detection part, a plurality of slits or sprocket holes as described by reference to FIGS. 1 and 7, respectively, are formed through the belt, in a row with a constant pitch. On the other hand, a magnetic sensor having a magnet-sensitive element is employed as the detector, and is disposed such that the magnetic sensor is opposed to the sequentially passing slits or sprocket holes. As the belt moves, the magnetic resistance is changed depending upon the presence and absence of the slits or sprocket holes, and therefore the magnetic sensor detects such a change in the magnetic resistance to detect whether any of the slits or sprocket holes is present at a position sensed by the sensor. Thus, the magnetic sensor can output an encoder signal similar to the encoder signal A as shown in FIGS. 1 and 7.

It is noted that in each of the above-described embodiments the drive source may not be the stepping motor 2, 32, but may be other kinds of motors, e.g., a DC motor.

The movable-body linear drive assembly according to the present invention can be utilized in: a uniaxial actuator of production machinery, when a hand mechanism or others is attached to the movable body; a recording apparatus, when a recording head part or recording pen is attached to the movable body; and a medical device such as a syringe pump, when a mechanism for holding a plunger of a syringe is attached to the movable body. The assembly is applicable to any other devices of simple structure with a movement status monitoring function, where a linear movement of a movable body is essential.

1. A movable-body linear drive assembly comprising:
a drive source;
a drive pulley connected to the drive source;
an idler pulley which is disposed such that the idler pulley is spaced from the drive pulley by a distance;
a belt which is wound around the drive pulley and the idler pulley, and which has a detection part;
a movable body mounted on the belt; and
at least one detector which detects the detection part of the belt.

2. The assembly according to claim 1, wherein the detection part consists of a plurality of slits each having a predetermined width, which are formed through the belt in a row with a constant pitch, and the detector consists of an optical sensor which detects whether any of the slits is present at a position sensed by the optical sensor.

3. The assembly according to claim 2, wherein the optical sensor is of transmission type.

4. The assembly according to claim 2, wherein the belt has a surface which reflects light, and the optical sensor is of reflection type.

5. The assembly according to claim 1, wherein a plurality of sprocket pins are provided on an outer circumferential surface of the drive pulley, the detection part consists of a plurality of sprocket holes each having a predetermined width, which are formed through the belt in a row with a constant pitch, and the detector consists of an optical sensor which detects whether any of the sprocket holes is present at a position sensed by the optical sensor.

6. The assembly according to claim 5, wherein the optical sensor is of transmission type.

7. The assembly according to claim 5, wherein the belt has a surface which reflects light, and the optical sensor is of reflection type.

8. The assembly according to claim 1, wherein the belt has a surface which reflects light, the detection part consists of a plurality of optically absorptive marks each in a band-like shape having a predetermined width, which are provided on the surface of the belt in a row with a constant pitch, and the detector consists of an optical sensor which detects whether any of the marks is present at a position sensed by the optical sensor.

9. The assembly according to claim 1, wherein the belt has a magnetic characteristic, the detection part consists of a plurality of magnetic marks each having a predetermined width, which are provided on the surface of the belt in a row with a constant pitch, and the detector consists of a magnetic sensor which detects whether any of the marks is present at a position sensed by the magnetic sensor, by observing a change in polarity in accordance with the alternate presence and absence of the marks.

10. The assembly according to claim 1, wherein the belt has a magnetic characteristic, the detection part consists of a plurality of slits each having a predetermined width, which are formed through the belt in a row with a constant pitch, and the detector consists of a magnetic sensor which detects whether any of the slits is present at a position sensed by the magnetic sensor, by observing a change in magnetic resistance in accordance with the alternate presence and absence of the slits.

11. The assembly according to claim 1, wherein the belt has a magnetic characteristic, the detection part consists of a plurality of sprocket holes each having a predetermined width, which are formed through the belt in a row with a constant pitch, and the detector consists of a magnetic sensor which detects whether any of the sprocket holes is present at a position sensed by the magnetic sensor, by observing a change in magnetic resistance in accordance with the alternate presence and absence of the sprocket holes.

12. The assembly according to claim 1, wherein the detector consists of a plurality of detectors.
